(19) United States
(12) Patent Application Publication
(10) Pub. No.: US 2007/0193420 A1
(43) Pub. Date: Aug. 23, 2007

(54) Method And Device For Loosening A Sticking Connection, In Particular A Glow Plug

(76) Inventor: Peter Gerardus Van Baal, PH IJsselstein (NL)

Correspondence Address: ST. ONGE STEWARD JOHNSTON & REENS, LLC, 986 BEDFORD STREET, STAMFORD, CT, 06905-5619, US

(21) Appl. No.: 11/680,422

(22) Filed: Feb. 28, 2007

Related U.S. Application Data
(63) Continuation of application No. PCT/NL05/00629, filed on Aug. 31, 2005.

(30) Foreign Application Priority Data
Aug. 31, 2004 (NL) 1026933

(51) Int. Cl. B25B 19/00; B25B 21/00; B23Q 5/00

(52) U.S. Cl. 81/463; 81/464; 173/47; 173/178

(57) ABSTRACT

A method and device are provided for loosening a sticking connection, in particular a glow plug in the cylinder head of an engine. The device comprises a mechanism for generating vibrations in an axial direction, preferably pneumatically, hydraulically or electrically, as well as means of transmitting the axial vibrations to the sticking connection, wherein the device also comprises means of exerting a couple, preferably read off or pre-adjustable, to the connection to be loosened. In the method, the sticking connection is subjected to preferably pneumatically, hydraulically or electrically generated axial vibrations, wherein a couple is also exerted on the sticking connection, preferably manually and pre-adjusted, in order to loosen it.

### CROSS-REFERENCE TO RELATED APPLICATIONS

The present application is a continuation of pending International patent application PCT/NL2005/000629 filed on Aug. 31, 2005 which designates the United States and claims priority from The Netherlands Patent Application No. 1026933 filed on Aug. 31, 2004, the content of which is incorporated herein by reference.

### FIELD OF THE INVENTION

The present invention relates in general to a method and device for loosening a sticking connection, for example a threaded connection, and in particular to the loosening of glow plugs in the cylinder head of an engine.

### BACKGROUND OF THE INVENTION

A device for loosening a threaded connection provided with a vibration/impact mechanism and an impact cap is known from U.S. Pat. No. 3,861,250. The vibration/impact mechanism comprises an impact plunger driven by compressed air which is an impact piece/connection piece and the impact cap exerts vibrations on the thread without exerting a torque on it.

It is generally known to persons skilled in the art of automotive and engine technology that glow plugs are difficult to remove from the cylinder head of an engine. This is due to a number of factors such as corrosion occurring between the thread of the glow plug and the thread of the cylinder head, carbon deposits between the cylinder head and the glow plug and the ‘eating away’ of the various metals, such as aluminum and steel. In this way the plug can stick very fast and there is a risk of it breaking during removal. Similar phenomena occur in atomisers, in particular of diesel engines, which are generally assembled with a clamp connections or adjustable fittings and which can also only be removed with difficulty due to corrosion and/or deposits.

The usual way of removing a glow plug from an engine is to warm up the engine, or to drive until it is warm if the glow plugs are still intact, leave them to glow by way of a separate cable for 4-5 minutes in order to burn them clean. Penetrating oil or an equivalent multifunctional oil is then applied to the thread after which the glow plug is carefully unscrewed using the correct tool. Here, the fitter must always ensure that a maximum torque which has been predetermined by the manufacturer, for example 40 Nm, is not exceeded as otherwise the glow plug can break off. The thread can also be damaged through the application of less than the maximum torque, depending on the extent of the corrosion and/or carbon depositing.

If the glow plug causes damage during disassembly and/or unexpectedly breaks, as is often the case, it has to be drilled out, after which the cylinder head has to be rethreaded. Drilling out the glow plugs and providing a new thread is a very time-consuming and risky operation. In many cases the cylinder head of the engine has to be dismantled and replaced itself, with all the additional costs involved.

U.S. Pat. No. 4,807,349 describes a device for loosening a threaded connection which is provided with a manually operated key and a vibration/impact mechanism. The vibration/impact mechanism exerts vibrations on the threaded connection without exerting a torque thereon. At the same time the threaded connection can be unscrewed with the key. In this device the vibration/impact mechanism acts on an impact plunger driven by a riveting machine. There is also no impact cap in this device.

German examined and published application (“Auslegeschrift”) 1 067 739 discloses a device for loosening a threaded connection is in which a plug key is specified as an application. The device is a manually operated key and comprises an impact mechanism. A hammer hits an impact mechanism whereby the force of the hammer is converted into a moment on the threaded connection (the “impact nut principle”).

U.S. Pat. No. 6,681,663 discloses a hand tool for loosening a threaded connection in which a vibration mechanism is included in the hand grip with which vibrations can be exerted on the thread without exerting a moment thereon. The threaded connection can then be unscrewed with the key.

Pneumatic turning/impact equipment is also known in accordance with the state of the art. For example, reference is made to U.S. Pat. Nos. 4,243,108 and 4,836,296.

Although much attention is paid in the literature to the problem of loosening sticking connections, and in particular threaded connections, until now none of the cited solutions has proven adequate in practice to routinely replace glow plugs of car engines etc. with a high success rate (i.e. without the plug breaking during assembly). There is therefore a need for further improvements to devices for loosening sticking connections, especially threaded connections and more particularly glow plugs, which are able to overcome the above problem or at least minimize it further. The criterion here is the percentage of plugs broken during removal from an engine block (or cylinder block as the case may be) by trained personnel decreasing or preferably considerably decreasing.

Surprisingly, it has now been found that this aim can be achieved by subjecting the sticking connection to axial vibrations, whereby at the same time a preferably controlled measurable couple is exerted on the connection to loosen it.

### SUMMARY OF THE INVENTION

Accordingly, the present invention provides a device for loosening a sticking connection which comprises a mechanism for generating vibrations in an axial direction as well as means of transmitting the vibrations to the sticking connection, wherein the device also comprises means of exerting a couple on the connection to be loosened.

Preferably, the axial vibrations are generated pneumatically or hydraulically.

Preferably, the means comprise a torque key or torsion rod for exerting a moment, with the couple preferably being adjustable.

In a further preferred embodiment for the sake of simplicity the torque key or torsion rod is detachably connected to the mechanism for generating vibrations in an axial direction. This can be achieved, for example, by equipping the housing in which an impact/vibration mechanism is preferably arranged with a device on or in which an external torque key can be arranged. The means of transmitting the vibrations to the threaded connection preferably also comprise a connection piece with which a vibration mechanism/impact mechanism of the device can be connected to the object to be removed from the threaded connection or to the thread itself. The device normally comprises an impact plunger driven by compressed air or hydraulically, which via an impact piece—connection piece and an impact cap exerts vibrations on the thread without exerting a moment. The vibration mechanism/impact mechanism also preferably comprises a very finely adjustable reduction valve with which the impact force frequency for the correct vibration energy can be set.

The device in accordance with the invention is primarily suited to loosening sticking threaded connections and in particular to the loosening and removal of glow plugs from an engine block in which glow plugs are mounted. The device is also suitable for loosening clamped or fitted connections and in particular for the loosening and removal of atomisers from a (diesel) engine block in which these atomisers are assembled. Thereby, in a suitable manner, use can be made of a suitable adapter or tool with which the atomiser, etc., is on the one hand firmly attached and which on the other hand is connected to the device in accordance with the invention in such a way that vibrations generated by the device in accordance with the invention are specifically transmitted to the atomiser etc. During or after the vibration process a couple is exerted on the sticking connection which in this case can also be an axial force in order to loosen the connection, as an atomiser generally has a thread. A suitable adapter is, for example, a variant of the apparatus shown in DE 20 2004 009 755 U1 whereby an additional device is applied in order to connect this apparatus with the device in accordance with the invention (see FIGS. 8 and 9 of the present application).

The device in accordance with the invention is also suitable for loosening fuse pins etc, usually using a standard adaptor, for example a ⅜ inch connection.

The invention also relates to a method of loosening a sticking connection, which comprises subjecting the sticking connection to pneumatically generated axial vibrations with a couple also being exerted on the sticking connection in order to loosen it.

Preferably, this couple can be read-off or is pre-adjustable. The couple is preferably also manually exerted on the sticking connection.

In principle, in a preferred embodiment of the invention the device operates as follows. By way of a known pneumatically operated vibration mechanism/impact mechanism the device generates axial vibrations, which are transmitted via an impact piece/connection piece to the object to be removed, typically, for example (the cover) of a glow plug, whereby the corrosion and the carbon deposits between the thread of the glow plug and the thread of the cylinder head are vibrated loose. In this way the friction between the two threads should be reduced to a greater or lesser degree. If the threaded connection is vibrated sufficiently loose, the glow plug can be unscrewed with a small couple during vibration and thus be removed complete from the cylinder head with less vibration energy. It is clear that the loosening process will depend on the extent to which the threaded connection is stuck and thus on the degree of corrosion and, in the case of glow plugs, of carbon deposits. The same principles apply if the connection to be loosened is not a threaded connection but a clamped or shaft connection.

The working duration is not particularly critical and normally takes from one minute to several minutes, depending on the degree of corrosion and/or carbon depositing and the frequency of the axial vibration mechanism. Preferably, prior to and/or during vibration penetrating oil or an equivalent is applied to the corroded connection. In a preferred embodiment of the device, the impact/vibration frequency can be adjusted. A suitable setting has, for example, a frequency in the range of around 3000-8000 vibrations/minute, preferably around 4000-6000 vibrations/minute, and most preferably around 5000 vibrations/minute. This corresponds to a pressure of the order of 5-10 bar. The couple that is manually exerted on the object to be loosened generally is critical, and certainly is so in the case of glow plugs. As a rule the limits indicated by the manufacturer should not be exceeded. If, after a few minutes of operation, the object still cannot be loosened, it should be repeated until the object can eventually be unscrewed.

If the glow plug still does not come loose, it is possible to unscrew the supply pin in the shaft of the plug and to tap a thread into the shaft (preferably a left-handed thread) and to apply a threaded rod or bolt with the aid of which better vibration can be transmitted to the sticking part of the glow plug, and generally at the same time reinforcing of the thread and casing can be brought about.

### BRIEF DESCRIPTION OF THE DRAWINGS

The invention will now be illustrated further by the following examples which are not to be construed as limiting scope of the invention in any respect and with reference to the accompanying drawings, in which:

FIG. 1 is a perspective view of a device in accordance with the invention in a preferred embodiment complete with a torque key;

FIG. 2 is a partial enlargement of the panel of the torque key indicator shown in FIG. 1;

FIG. 3 is another perspective view of a device in accordance with the invention without a torque key or torsion rod;

FIG. 4 is a top view of a device in accordance with FIG. 1 or FIG. 3;

FIG. 5 is a schematic cross-section of the device in accordance with the invention taken on the line A-A in FIG. 3;

FIG. 6 is a schematic cross-section of the device in accordance with the invention taken on the line B-B in FIG. 4;

FIG. 7 is a schematic perspective view of another device in accordance with the invention in its various components;

FIG. 8 is a schematic perspective view of an embodiment of the device in accordance with the invention with an adapter suitable for vibrating loose and removing atomisers; and

FIG. 9 is a schematic cross-section of the device and adapter in accordance with FIG. 8.

### DETAILED DESCRIPTION OF THE INVENTION

It should be noted that for the sake of clarity in the various figures the same reference numbers are used as far as possible for the same or equivalent components.

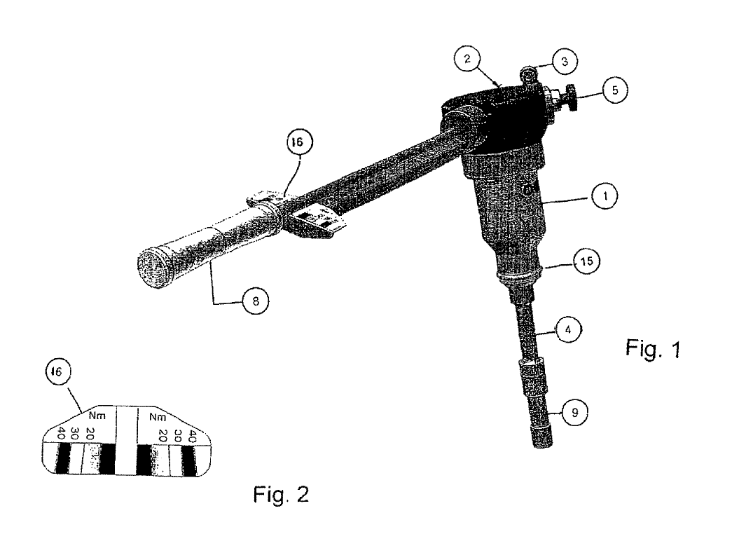

With reference to FIG. 1 a device in accordance with the invention is shown which comprises three principal components:

A. A section with a conventional pneumatic vibration mechanism, which mainly comprises the following components: a casing 1, in which the vibration mechanism is essentially located, including a cover, and a head 2 which is connected to the casing by way of bolts 4, with a compressed air connection 3, an air regulating valve 5 and a torque key 8 being mounted on the head 2. In place of a pneumatic vibration mechanism another vibrating mechanism with equivalent operation can be used, such as an electric or hydraulic vibration mechanism. Such variants are known to persons skilled in the art.

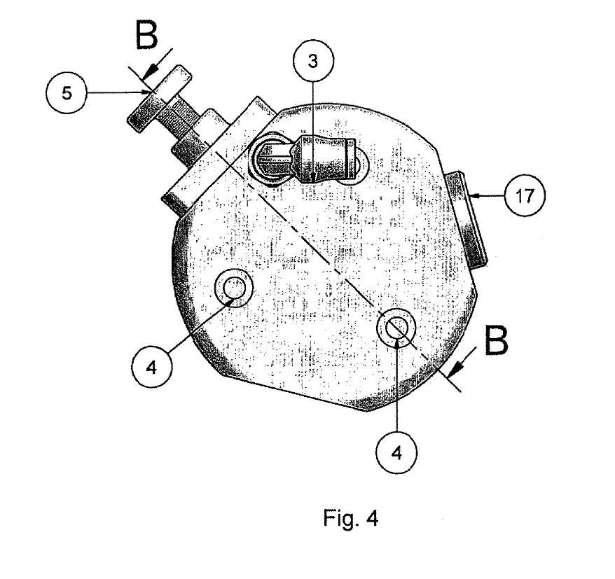

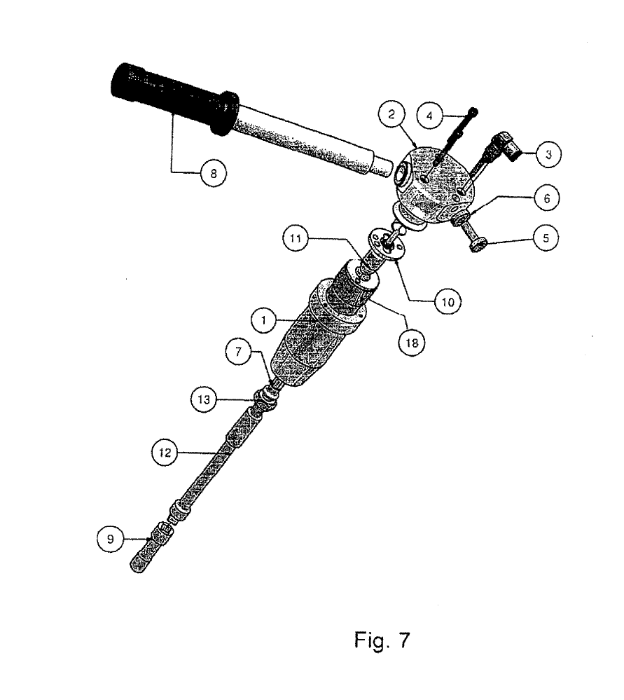

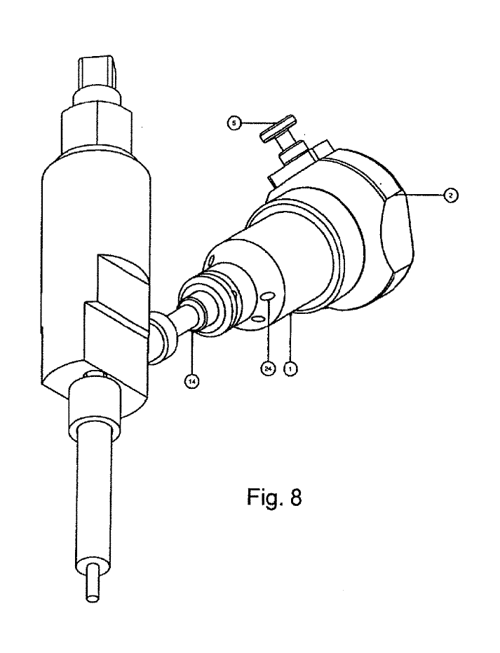

B. A torque key 8, in this embodiment an indicator moment key with a reader panel 16, which is shown partially enlarged in FIG. 2. Instead of an indicator torque key an adjustable torque key or torsion rod can be used, but the illustrated form of embodiment is preferred at present. The torque key or torsion rod 8 is usually detachably connected to the head 2, as shown for example in FIG. 4 or FIG. 7.

C. An impact cap 9, usually hexagonal, which is connected via a vibration rod 14 to the vibration mechanism in casing 1, whereby the vibration rod is locked with the locking pins 15. Via the vibration rod 14 the axial vibrations generated by the vibration mechanism are transmitted to the impact cap 9 and thereby to the sticking connection to be loosened.

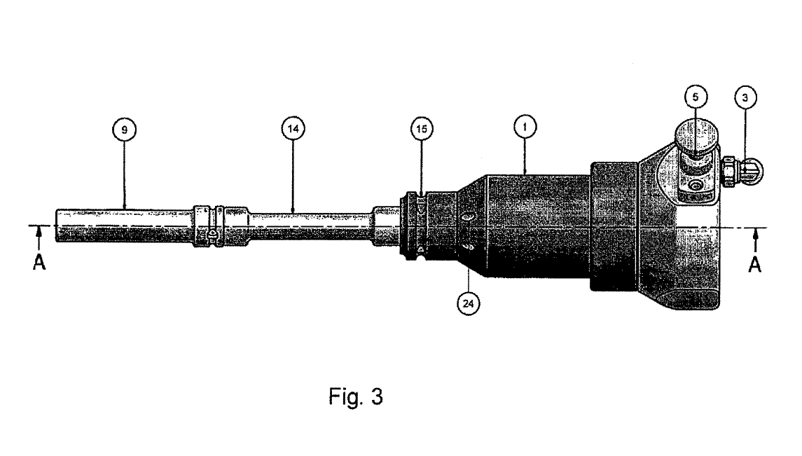

With reference to FIG. 3 a device according to the invention in shown which is essentially identical to the device in FIG. 1 but without a torque key or torsion rod and in another perspective. FIG. 3 thus shows a device comprising a casing 1, which mainly contains a vibration device, a head 2, with a compressed air connection 3 and an air 5 regulating valve 5. An impact cap 9 is attached to the vibration mechanism via a vibration rod 14 which is locked to the casing 1 at 15. In the casing 1 there are also openings 24 for venting the return chamber of the vibration mechanism, the operation of which will be described in further detail below.

With reference to FIG. 4 the head 2 of a device in accordance with the 10 invention is shown from the top, where 3 is again the connection of the compressed air line and 5 an air regulating valve. The head is fixed to the casing with the bolts 4. The head in this embodiment is also provided with a precision-fit flange 17 or a thread for accommodating a torque key or torsion rod.

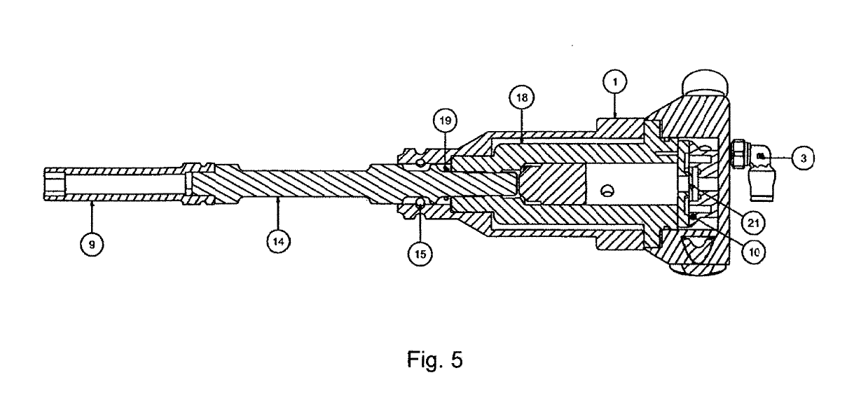

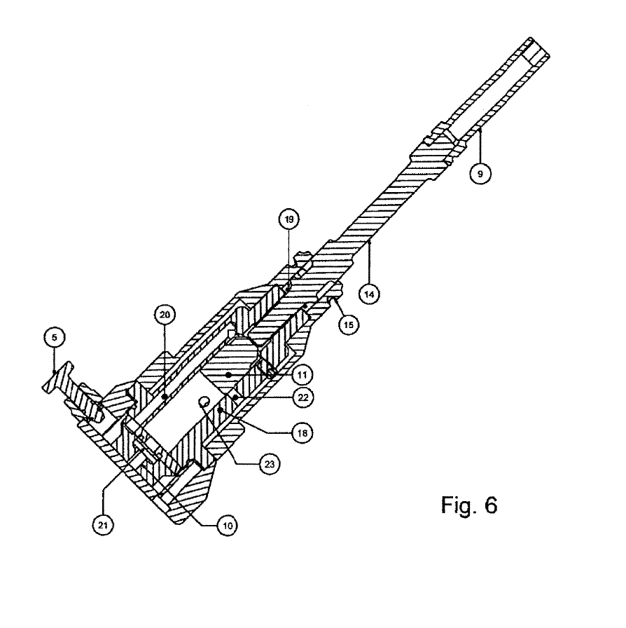

With reference to FIG. 5 and FIG. 6 two different longitudinal sections of the 15 same device in accordance with the invention are shown. Using these the operation of a conventional type of vibration mechanism that can be advantageously used in the device will now be described. The vibration mechanism is mainly located in the casing 1 and is bounded at one end of the casing by the head 2 and at the other end by the vibration rod 14. The vibration mechanism comprises a cylinder 18 in which a plunger 11 is moved back 20 and forth. It will be clear to a person skilled in the art that on the one hand it fits tightly to the internal wall of the cylinder and other hand it must be able to move easily in the cylinder. The plunger 11 divides the cylinder 18 into two chambers which hereinafter are referred to as the pressure chamber and the return chamber. The pressure chambers is close to the edge of the head 2, while the return chamber is bounded by the vibration rod 25 14 at the end that is removed from the plunger 11.

The operation of the vibration mechanism is based on the rapid to and fro movement of the plunger 11. Compressed air is fed via the inlet 3 into the head 2 and there passes through the air regulating valve 17 via a supply channel. The air is then fed via the valve 10 with the change-over valve 21 into the pressure chamber as a result of 30 which the plunger 11 is moved in the direction of the vibration rod 14 giving the vibrating rod an impulse. By way of the described movement of the plunger 11 in the cylinder 18 an opening 23 in the cylinder wall is made free through which the air flows through the casing to the outside and the pressure in the pressure chamber is released. In this way the change-over valve 21 closes too as a result of which the compressed air now flows into 35 the return chamber via air channel 20 and pushes the plunger 11 due to its adapted shape back in the direction of the head 2. Through this movement the opening in 23 in the cylinder wall is closed and an opening 22 in the cylinder wall is opened through which the air flows out through the opening(s) 24 via an air channel and the pressure in the return chamber is released. At the same time the change-over valve 21 opens again as a result of which the compressed air flows into the pressure chamber and the process described above begins again. The plunger 11 is thus rapidly moved to and fro and this generates a vibration of the vibration rod 14, which is passed on to any impact cap 9 mounted thereon. The air channel 20 (see FIG. 6) thus has the function of controlling the change-over valve 21. It will be clear to a person skilled in the art that the vibration mechanism is controlled by the pressure from the supplied compressed air which in the first instance is externally determined and then finely regulated by the regulating valve 5. The fastening of the impact cap on the vibration rod can be any type of conventional fastening which is known to a person skilled in the art, such as a clamping spring or other locking device. The vibration rod 14 is fastened in a moveable manner to the casing 1 by means of a locking device 15, for example locking pins. Preferably a buffer ring 19 is arranged around the vibration rod close to the end that limits the cylinder 18 and closely fitting the inner edge of the casing 1. The buffer ring 19 serves both to counteract leakage of air from the pressurized system which promotes good operation of the vibration mechanism, as well as to absorb the pulses produced by the vibration mechanism so that more vibration energy remains in the vibration rod and does not enter the machine as negative energy. Preferably the buffer ring is made of a durable elastic plastic or rubber. Preferably the locking pins 15 are made of a hard plastic.

Modifications of the vibration mechanisms are also envisaged, but the application of these does not differ from the described principle.

With reference to FIG. 7 another form of embodiment of the device in accordance with the invention is shown. The casing 1, including protection is here shown in an axial downward embodiment, but in the operating condition this is attached to the head 2. In the head 2 the holes for the supply of compressed air 3 and the bolts 4 are visible. The air regulating valve 5 is locked by an external lock nut 6 in this embodiment. In other forms of embodiment locking normally takes place by means of an O-ring (not shown) or in another way which is known to a person skilled in the art. In place of a vibration rod an impact pin 7 is used in this embodiment, which together with the connection piece 12 and the locking nut 13 has an identical function to the vibration rod in the previously described embodiments. The valve 10 and the cylinder 18 with the impact plunger 11 are also shown and also have identical functions as described. A torque key 8 in this case of an adjustable click type and an impact cap 9 usually of a hexagonal design are also shown.

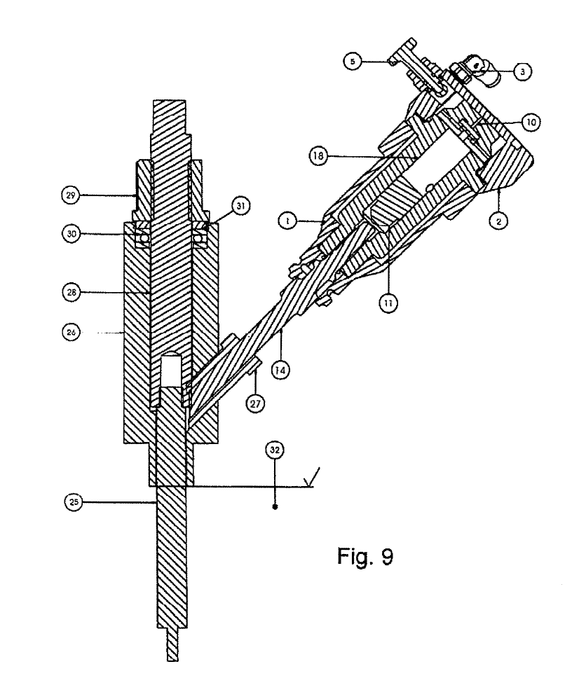

With reference to FIG. 8 and FIG. 9 another form of embodiment of the invention is shown, comprising a device in accordance with the invention as well as an adapter 5 suitable for vibrating loose and removing an atomiser 25 which is inserted in a cylinder head 32. The device does not essentially differ from the previously described forms of embodiment except that the vibration rod 14 is designed with a angled end, normally at an angle of 45° with regard to the longitudinal direction of the rod, which by means of suitable adapter is preferably directly brought into contact with an atomiser 25 or a tension spindle 10 28 for an atomiser. The tension spindle 28 shown here is derived from a conventional type and comprises a support cylinder 26, a bearing ring 30, a support plate 31 and a tightening nut 29. Preferably the support plate comprises an angle correction whereby there is a greater chance that the atomiser can be drilled loose and removed under the applicable circumstances. This type of tension spindle is known to a person skilled in the 15 art and will not be described further. The new element in this adapter is the guide bush 27 for the also used vibration rod 31, whereby the device according to the invention can exert effective axial vibration on the atomiser. As an atomiser does not generally have a thread it is in this case not necessary to apply a (manual) radial force on the atomiser in order to loosen it, as described above, but the atomiser can be loosened and removed by axial 20 force as well as by tightening the nut 29.

The material of which the device according to the invention is manufactured is preferably high-quality steel for the ‘heavy’ parts which generate and/or transmit the vibrations, such as the vibration rod 14 or the impact pin 7, the impact plunger 11, the extension piece 12, the impact cap 9 and generally also the torque key 8, and lightweight 25 metal, such as aluminum for the casing 1 and the head 2. Where necessary or required the head 2 is reinforced. For a person skilled in the art the choice of material and any variations thereof will not present any problem.

The shown torque keys or torsion rod form part of the device according to the invention but are not generally integrally connected to the head of the vibration device. 30 However, such a form of embodiment is envisaged in the scope of this invention. The torque key can also be provided at another place, for example on the casing 1 with the vibration/impact mechanism or between the casing 1 and the object to be removed, in the same way as described in U.S. Pat. No. 4,807,349. A form of embodiment is also envisaged in which no manual, but a mechanical or electrical couple is exerted.

In place of the impact cap shown as component C, which is mainly of use when loosening and removing glow plugs, any other connection piece can be applied between the vibration mechanism and the object to be removed. This component can also form an integral unit with, for example, the impact piece-connection piece 12.

For a person skilled in the art it will be clear that modifications and adaptations to the device described in this application can be made without deviating from the essence of the invention. Such modifications and adaptations, some of which are set out above, are therefore included in this invention.

What is claimed is:

1. A device for loosening a sticking connection, comprising a mechanism for generating vibrations in an axial direction, as well as means of transmitting the axial vibrations to the sticking connection, characterized in that the device also comprises means of exerting a couple to the connection to be loosened.

2. The device according to claim 1, wherein axial vibrations are generated pneumatically.

3. The device according to claim 1, wherein axial vibrations are generated hydraulically.

4. The device according to claim 1, wherein axial vibrations are generated electrically.

5. The device according to claim 1, wherein the couple can be read off.

6. The device according to claim 1, wherein the couple is pre-adjustable.

7. The device according to claim 1, wherein the means of exerting a couple comprise a torque key.

8. The device according to claim 1, wherein the means of exerting a couple comprise a torsion rod.

9. The device according to claim 7, wherein the torque key is connected in a detachable manner to the mechanism for generating vibrations in an axial direction.

10. The device according to claim 8, wherein the torsion rod is connected in a detachable manner to the mechanism for generating vibrations in an axial direction.

11. The device according to claim 2, wherein the mechanism for generating axial vibrations comprises a pneumatically operated vibration/impact mechanism.

12. The device according to claim 11, wherein the pneumatically operated vibration/impact mechanism also comprises a reducing valve with which the impact force frequency can be adjusted.

13. The device according to claim 1, wherein the sticking connection is a threaded connection.

14. The device according to claim 1, wherein the sticking connection is a fitted connection.

15. The device according to claim 1, wherein the sticking connection is a connection of a glow plug or an atomiser with an engine block, in which the glow plug or atomiser is assembled.

16. A method of loosening a sticking connection in which the sticking connection is subjected to pneumatically, hydraulically or electrically generated axial vibrations, characterized in that a couple is also exerted on the sticking connection in order to loosen it.

17. The method according to claim 16, wherein the sticking connection is subjected to pneumatically generated vibrations.

18. The method according to claim 16, wherein the couple is manually exerted on the sticking connection.

19. The method according to claim 16, wherein the sticking connection is a threaded connection or a fitted connection.

20. The method according to claim 16, wherein the sticking connection is that of a glow plug or an atomiser with an engine block in which the glow plug or atomiser is assembled.

21. The device according to claim 1, wherein the mechanism for generating vibrations in an axial direction comprises a vibration rod, whereby a buffer ring is arranged around the vibration rod as defined herein.
